(19) United States
(12) Patent Application Publication
(10) Pub. No.: US 2013/0282530 A1
(43) Pub. Date: Oct. 24, 2013

(54) System and Method for Choosing a Contractor

(71) Applicant: Devinder Singh, North Wales, PA (US)

(72) Inventor: Devinder Singh, North Wales, PA (US)

(21) Appl. No.: 13/857,687

(22) Filed: Apr. 5, 2013

Related U.S. Application Data
(60) Provisional application No. 61/635,276, filed on Apr. 18, 2012.

(51) Int. Cl. G06Q 30/06

(52) U.S. Cl. CPC G06Q 30/0627
USPC 705/26.63

(57) ABSTRACT

A method for allowing a user to select a contractor is provided. The method includes providing a contractor database, the database allowing the contractor to input contractor information; displaying a list of tasks that the contractor offers to perform and a billable rate at which the contractor offers to perform each task on the list; allowing the user to input a list of desired tasks to be performed and available dates for the contractor to perform each desired task; generating a list of contractors available to perform the desired tasks within the available dates; and allowing the user to select a contractor from the list of contractors. A non-transitory machine-readable storage medium for performing the method is also provided.

### CROSS-REFERENCE TO RELATED APPLICATION

This application claims priority from U.S. Provisional Patent Application Ser. No. 61/635,276, filed on Apr. 18, 2012, which is incorporated herein by reference in its entirety.

### FIELD OF THE INVENTION

The present invention relates to a system and a method for choosing a contractor for home repair work, and for a contractor to manage and schedule his workload.

### BACKGROUND OF THE INVENTION

When homeowners desire to have work done on their homes, many homeowners are unaware of the quality of contractors before engagement to perform the work. Unfortunately, some contractors cannot adequately meet the needs of the homeowner, particularly with regard to scheduling timeframes to perform the work. For example, homeowners may require that they are home when the contractor is performing the work and so the homeowners must juggle the contractor's schedule with their working schedule. Additionally, homeowners may require the work to be completed before a certain date or event, such as painting the inside of the house before a big party.

It would be beneficial to provide a system that allows a homeowner determine qualified contractors who can perform required work and are available to perform the work within the homeowner's schedule.

### BRIEF SUMMARY OF THE INVENTION

Briefly, the present invention provides a method for allowing a user to select a contractor. The method includes providing a contractor database, the database allowing the contractor to input contractor information; displaying a list of tasks that the contractor offers to perform and a billable rate at which the contractor offers to perform each task on the list; allowing the user to input a list of desired tasks to be performed and available dates for the contractor to perform each desired task; generating a list of contractors available to perform the desired tasks within the available dates; and allowing the user to select a contractor from the list of contractors.

A system for electronically performing the method is also provided.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic view of a system for storing and managing contractor and customer information according to a first exemplary embodiment of the present invention;

FIG. 2 is a graphical user interface (“GUI”) of a Login/Registration page according to an exemplary embodiment of the present invention;

FIG. 3 is a GUI of a Contractor/Consumer selection page according to an exemplary embodiment of the present invention;

FIG. 4 is a GUI of a Contractor Registration page according to exemplary embodiment of the present invention;

FIG. 5 is a GUI of a Contractor Registration value selection page according to an exemplary embodiment of the present invention;

FIG. 6 is a GUI of a Contractor Registration license input page according to an exemplary embodiment of the present invention;

FIG. 7 is a GUI of a Contractor Registration License information page according to an exemplary embodiment of the present invention;

FIG. 8 is a GUI of a Contractor Registration detail specification page according to an exemplary embodiment of the present invention;

FIG. 9 is a GUI of a Contractor Registration day availability page according to an exemplary embodiment of the present invention;

FIG. 10 is a GUI of a Contractor Registration appointment information page according to an exemplary embodiment of the present invention;

FIG. 11 is a GUI of a contractor calendar according to an exemplary embodiment of the present invention;

FIG. 11A is a GUI of an external appointment added to a contract calendar according to an exemplary embodiment of the present invention;

FIG. 12 is a GUI of a contractor weekly schedule update page according to an exemplary embodiment of the present invention;

FIG. 13 is a GUI of a task update page according to an exemplary embodiment of the present invention;

FIG. 14 is a GUI of a contractor task page that allows selected tasks to be deleted according to an exemplary embodiment of the present invention;

FIG. 15 is a GUI of a contractor task page that allows selected tasks to be added according to an exemplary embodiment of the present invention;

FIG. 16 is a GUI for the calendar that allows a contractor to set special rates per day according to an exemplary embodiment of the present invention;

FIG. 17 is a GUI that allows the contractor to modify the special rates shown FIG. 16 according to an exemplary embodiment of the present invention;

FIG. 18 that allows a consumer to select a task to be performed by a contractor according to an exemplary embodiment of the present invention;

FIG. 19 is a GUI that allows the consumer to search available contractors according to an exemplary embodiment of the present invention;

FIG. 20 is a GUI that allows the consumer to add project according to an exemplary embodiment of the present invention;

FIG. 21 is a GUI that allows the consumer to select a task according to an exemplary embodiment of the present invention;

FIG. 22 is a GUI that provides a list of potential contractors that may be selected based on consumer input according to an exemplary embodiment of the present invention;

FIG. 23 is a GUI that provides appointment details for the consumer according to an exemplary embodiment of the present invention;

FIG. 24 is a GUI that shows appointment confirmation for the consumer according to an exemplary embodiment of the present invention;

FIG. 25 is a block diagram illustrating the combination of the flowcharts of FIGS. 25A and 25B;

FIG. 25A is a flowchart illustrating contractor/consumer interface steps after the consumer has initially selected contractor according to an exemplary embodiment of the present invention; and

FIG. 25B is a continuation of the flowchart of FIG. 25A.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. As used herein, a “contractor” is a party that performs work at is requested by a “customer” or a “consumer” or a “homeowner”. Additionally, a “user” of the inventive system may be either a contractor or a customer/consumer/homeowner, depending upon the user's needs for the inventive system. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Referring to the figures, the present invention provides a system 100 and a method for choosing a contractor from an electronic database 110. System 100 allows a contractor to input his/her information into system 100 via a contractor input module 120 and also allows a consumer to input his/her information into system 100 via a homeowner input module 130. As will be discussed later herein, some information maintained in database 110 is accessible only to contractors, whereas other information maintained in database 110 is accessible only to consumers.

System 100 allows a consumer to select a contractor based on the contractor's unit price for performing specified tasks and also allows the consumer to provide rating feedback regarding the contractor after the contractor has completed the specified tasks. System 100 also allows the contractor to schedule tasks or projects, including those he or she received from external sources, such as, for example, his own advertising, as well as those that are scheduled through system 100 and to indirectly provide his/her availability to the consumer, as the contractor's availability for future projects is calculated by system 100 based on projects previously entered by the contractor, so that, in addition to price, the consumer can select the contractor based on the contractor's availability.

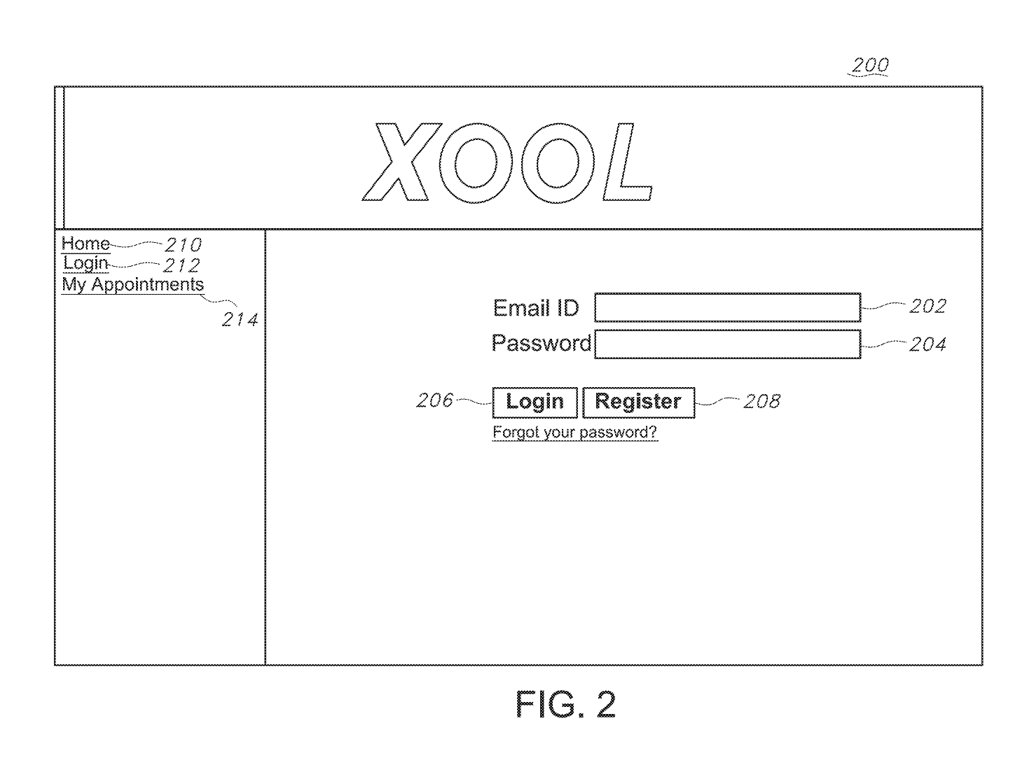

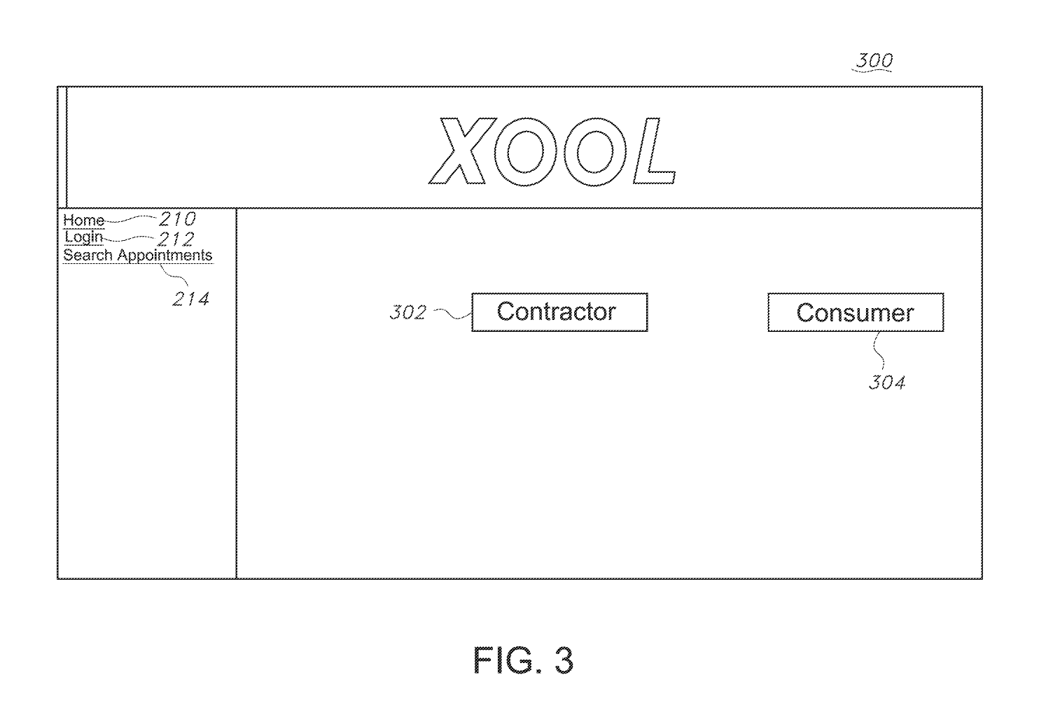

For either a contractor or a homeowner to access system 100, the contractor/consumer accesses system 100, which initially generates GUI 200, shown in FIG. 2. GUI 200 includes a block 202 for the user to input his/her e-mail username and a password block 2042 input his/her password. If the user has previously registered with system 100, user can click on the “Login” box 206, which takes the user to GUI 300 in FIG. 3.

Referring to FIG. 2, each GUI includes, on the left-hand side of the screen, a “Home” icon 210, a “Login” icon 212 and a “Search Appointments” icon 214. If the user clicks on “Home” icon 210, system 100 generates GUI 300, shown in FIG. 3. If user clicks on “Login” icon 212, GUI 200 appears.

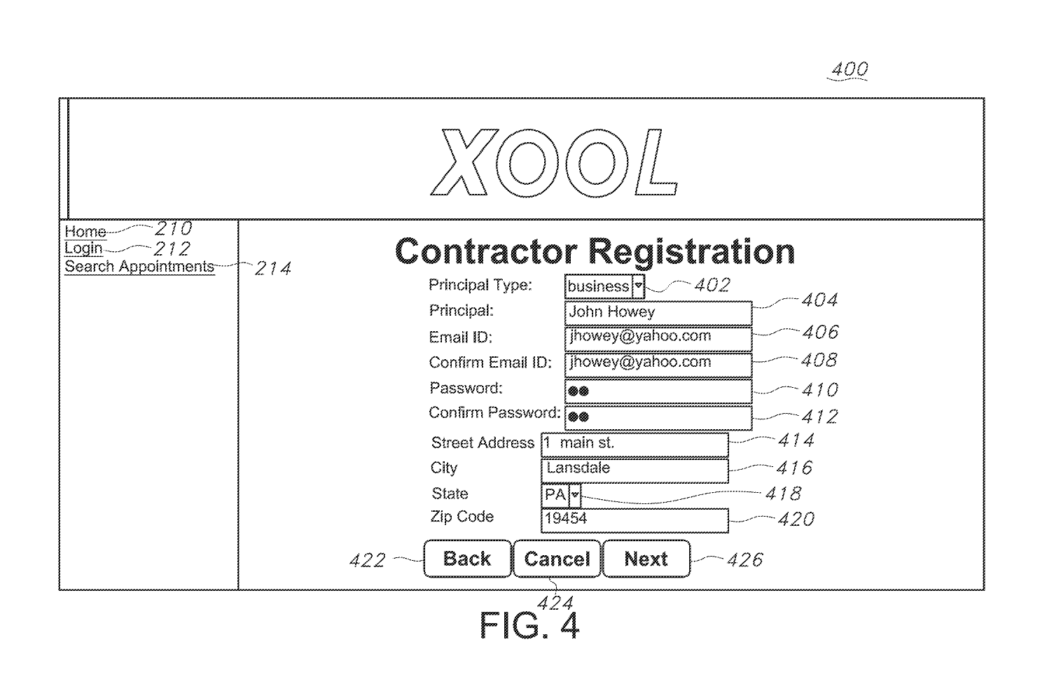

If the user is new to system 100, prior to inputting his/her e-mail username and password, the user clicks on “Register” block 208, which generates GUI 300, shown FIG. 3. FIG. 3 includes a “Contractor” box 302 and a “Consumer” box 304. If the user is a contractor, the user clicks on box 302, which generates GUI 400, shown FIG. 4. GUI 400-1700 (FIGS. 4-17) are screens that are accessible to contractors only; consumers cannot access the screens.

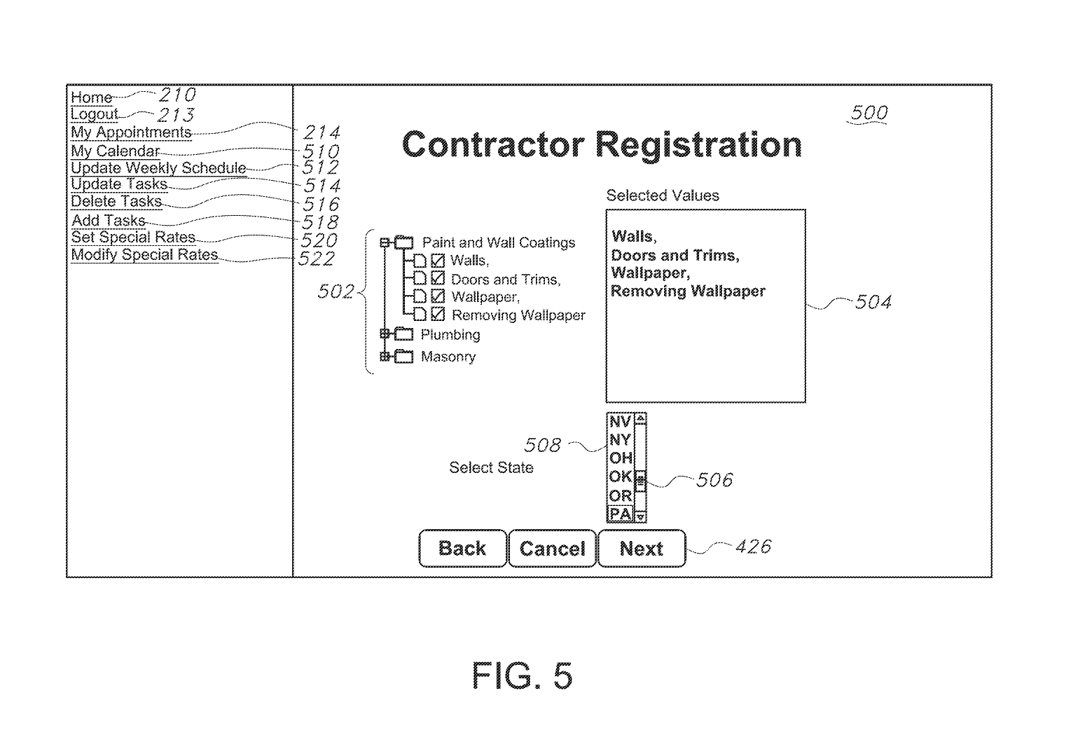

FIG. 4 allows the user to select or input his/her business and contact information in blocks 402-420. If the user clicks on “Back” box 422, the user is taken back to the previous screen, in this case, GUI 300 shown in FIG. 3. If the user clicks on “Cancel” box 424, any information that was previously input in any of blocks 402-420 is removed. If the user clicks on “Next” box 426, GUI 500, shown FIG. 5, appears.

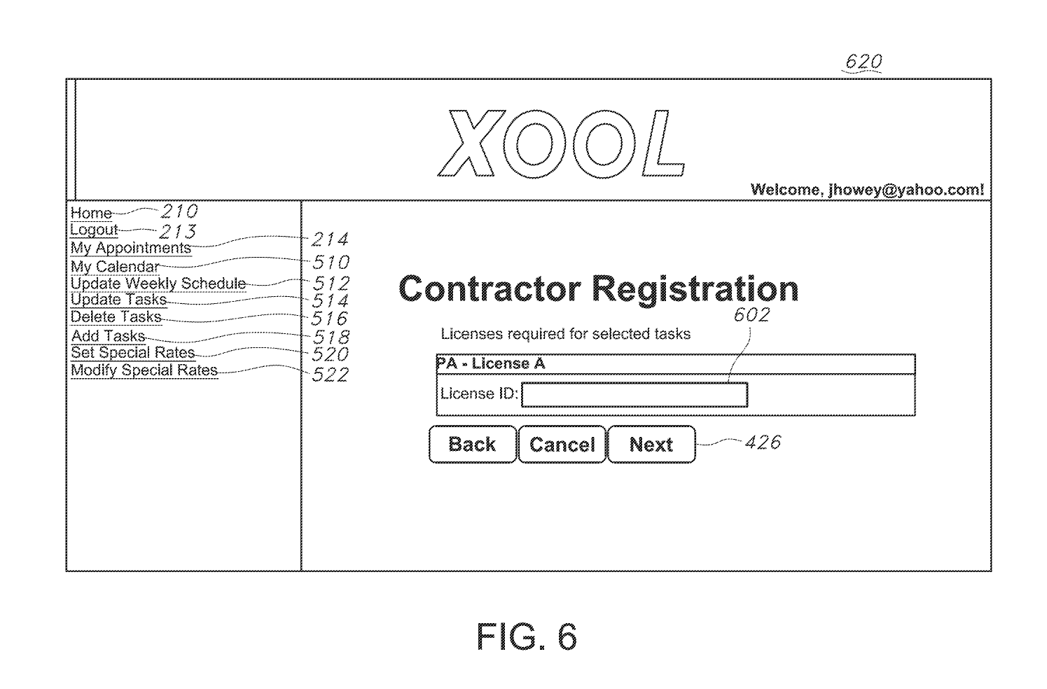

GUI 500 provides a plurality of tasks 502 that the contractor can select as tasks that he can perform. As each of the tasks 502 is checked off, the task is printed in a window 504. Also, the user can select the states in which he/she is licensed to provide contracting services by manipulating a slider bar 506 that highlights abbreviations for states in column 508. When the user gets to the selected state, the user clicks on that state and clicks the “Next” button 426, which generates GUI 620, shown FIG. 6.

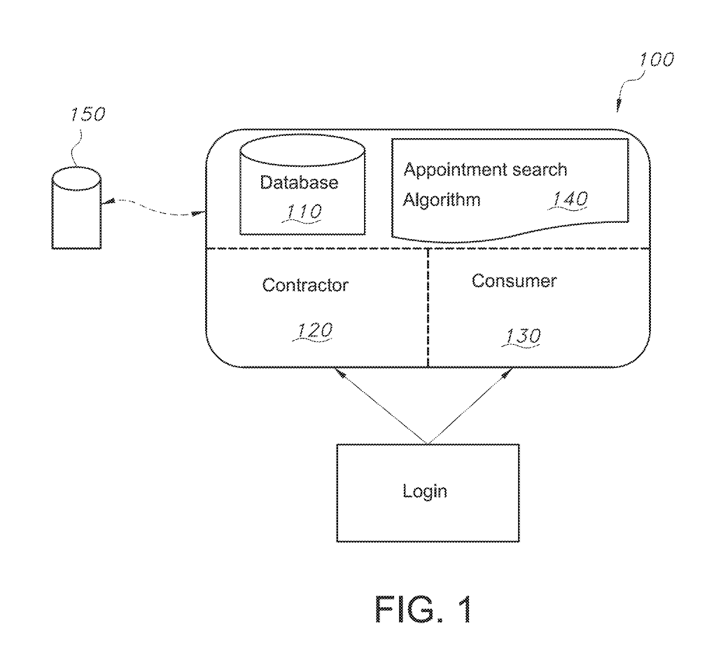

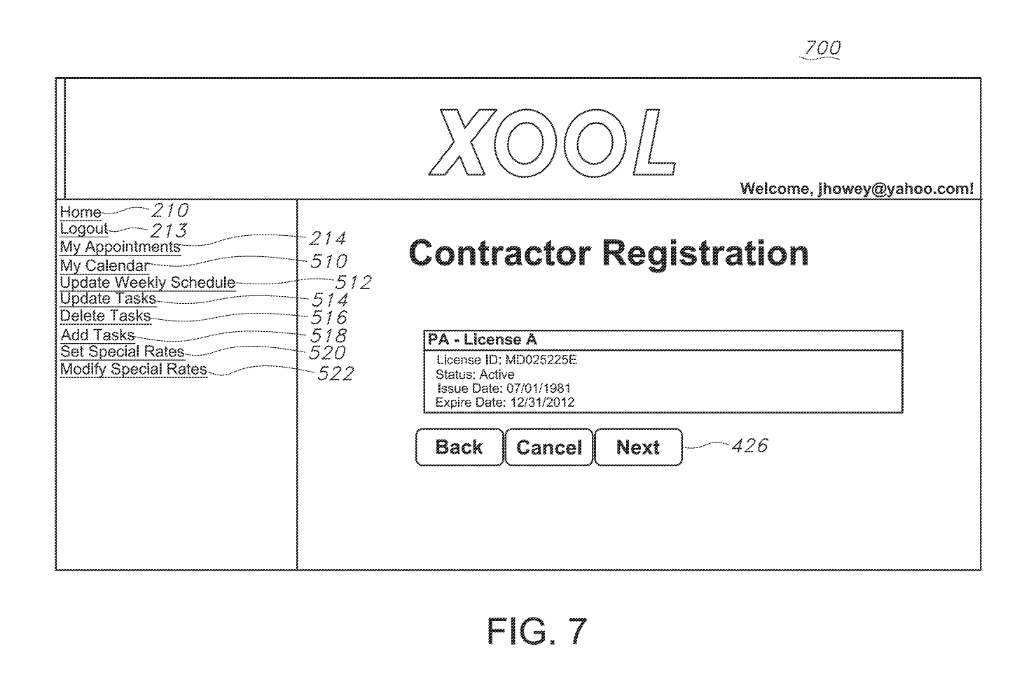

Based on the state that the user selected in GUI 500, the user can input his/her license identification number in box 602. When the user clicks on the “Next” button 426, system 100 generates GUI 700, shown FIG. 7 and also electronically reaches out to an external licensing database 150 (shown FIG. 1), which can be obtained from respective state(s), to retrieve and display the user's licensing information for the selected state. If the user is not licensed in that state, if the users identification information is incorrect, or if the user's license in that state has expired, system 100 displays an error message indicating the failure and the contractor is unable to continue to register with the website.

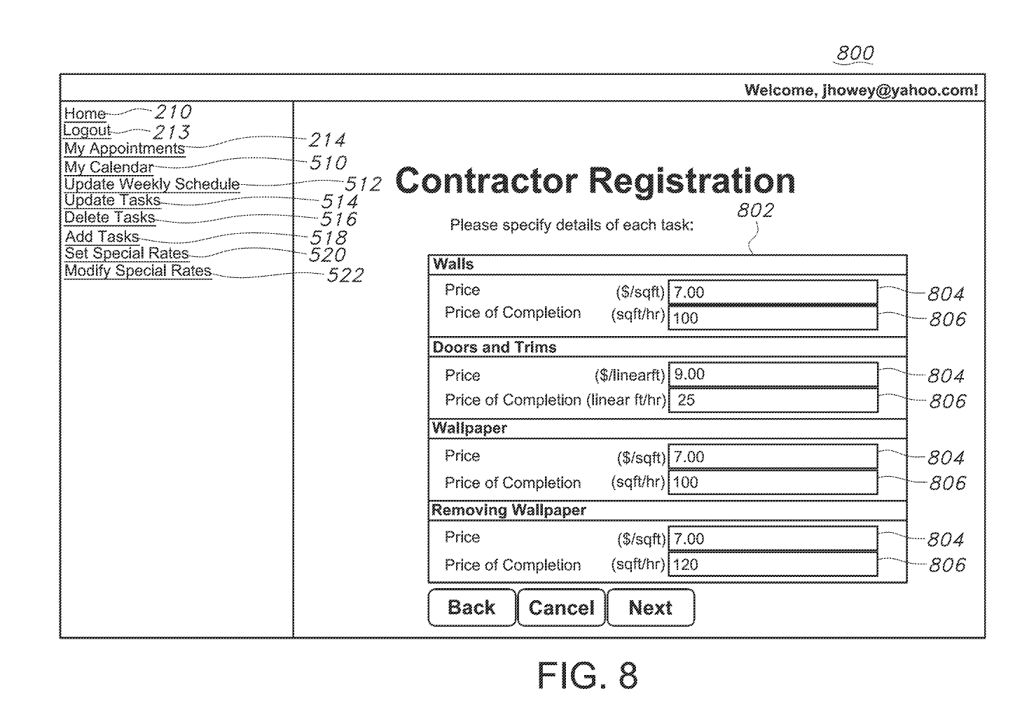

If the contractor's license information corresponds to the information retrieved from licensing database 150, contractor can click on button 426, which generates GUI 800, shown FIG. 8. Additionally, if a contractor successfully registers with the website but later on allows his/her license to expire, his/her information will not be shown on the search results performed by the homeowners or consumers.

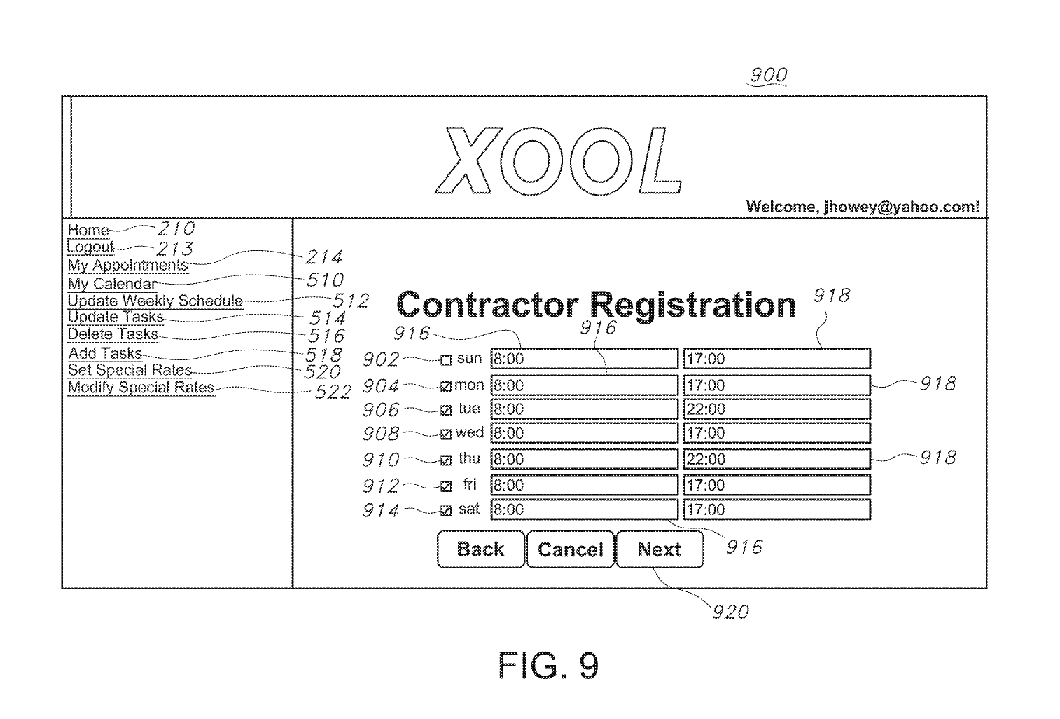

Based on the tasks 502 that the user selected in GUI 500, each task is displayed in block 802. For each task, a price per unit measurement block 804 and a rate of completion block 806 is provided. The user inputs his/her information in blocks 804 and 806 and when he/she is finished, clicks on the “Next” button 426, which generates GUI 900, shown FIG. 9. In addition to price per unit and rate of completion, system 100 can also take other data from the contractor, based on which system 100 can accurately calculate a quote for the work requested by a consumer. This data includes, but is not limited to, a minimum price for which contractor will take any project, and zipcode-specific or area-specific prices if the contractor charges different rates for different areas.

FIG. 9 allows the user to select if he/she is available to work by checking respective ones of blocks 902-914, inputting start times in box 916 and ending times in box 918 for each respective day. After the user has input this information, user clicks on “Finished” box 922 finished inputting his/her contact information.

Additionally, referring to FIGS. 5-9, “Login” icon 212 has been replaced with a “Logout” icon 213. If the user clicks on “Logout” icon 213, system 100 generates GUI 200, shown FIG. 2.

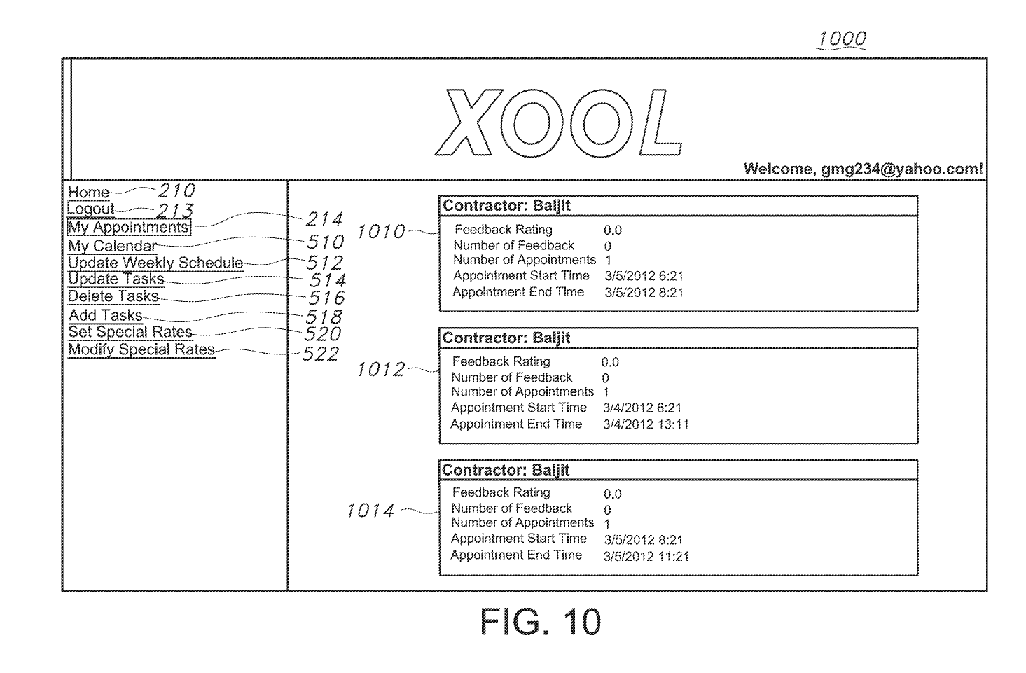

In addition to icons 210-214 on the left-hand side of the screen, GUI 500 further includes additional icons 510-522 that can be selected to add or modify information. If, from any of GUI 500-900, the user clicks on icon 214, GUI 1000, shown in FIG. 10, is generated.

GUI 1000 displays upcoming appointments in blocks 1010-1014. Each appointment block 1010-1014 displays a Feedback Rating, a Number of Feedbacks, a Number of Appointments, and Appointment Start Time and End Time. In addition to appointment start and end date, system 100 also shows all the appointment slots that are booked to complete the whole appointment. For example, a project may take five (5) working days to complete, so the appointment blocks will show five (5) sub appointments, so that contractor knows what all days he is supposed to go to a particular customer's home to complete the project. GUI 1000 allows the contractor to determine when he/she started and ended a job so that he/she can properly generate a bill for the customer. System 100 can also generate a bill for the customer based on all the data that has been collected by the system. The hourly rate for the selected task is multiplied by the estimated time or the actual time used to complete the task. The customer's address information is retrieved from database 110 and used to generate a bill. Additionally, the customer's e-mail address can be used to transmit the bill, with a copy of the bill being also transmitted to the contractor's e-mail address.

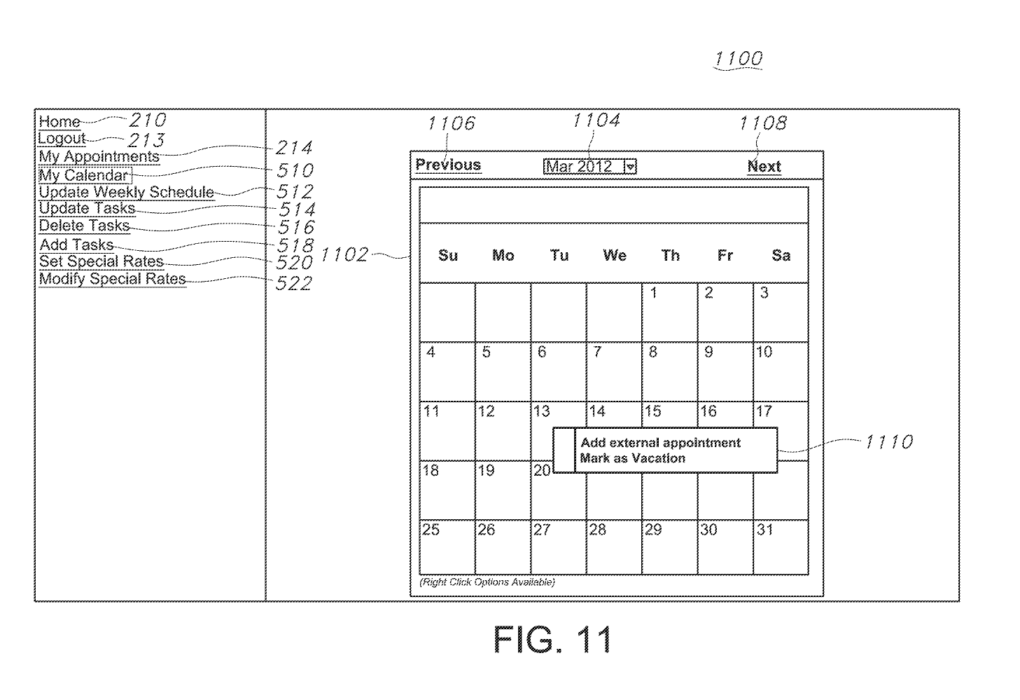

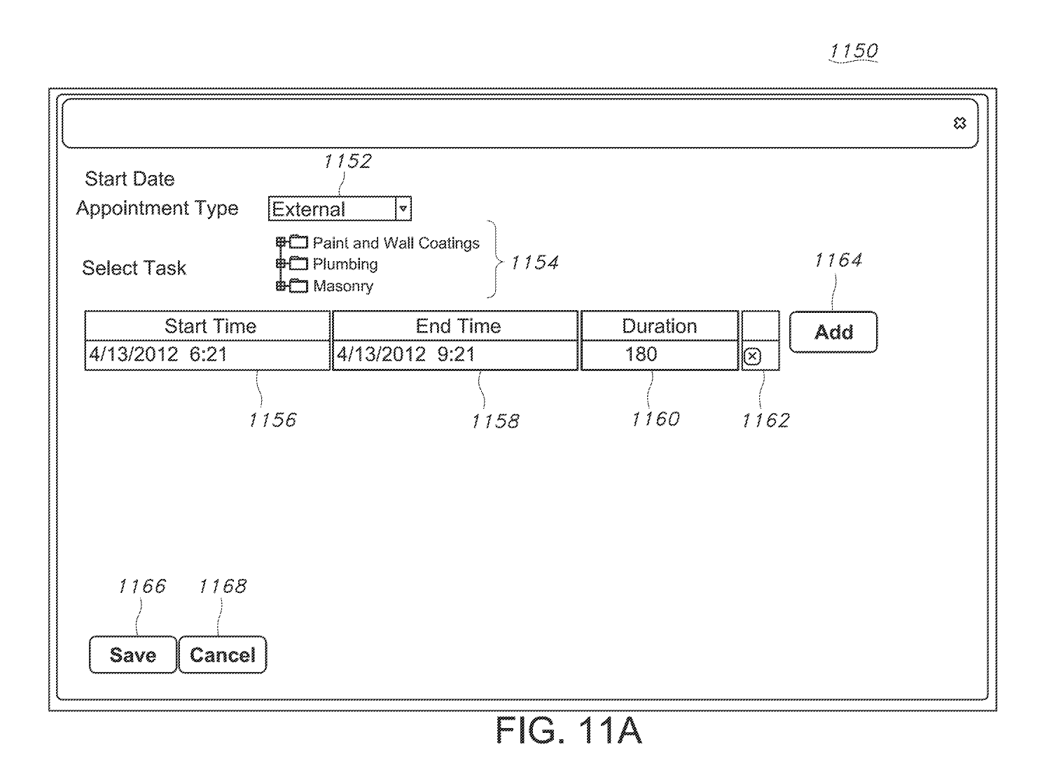

If the user clicks on “My Calendar” icon 510, GUI 1100, shown FIG. 11, is generated. A calendar 1102 is provided, showing the month and year in block 1104. Icon 1106 can be clicked on to generate the previous month's calendar and icon 1108 can be clicked on to generate the next month's calendar. Optionally, the user will be able to use system 100 to schedule his manpower based on the user's workload as shown on calendar 1102. In addition, although not shown, system 100 may provide a feature for the user to upload pictures of himself/herself along with all his/her employees/coworkers. This feature will allow the consumer to identify the personnel who may be coming to his/her house to perform the contracted work.

The contractor can right click on calendar 1102 to allow the contractor to add an appointment that was generated by other than system 100 and mark dates that are unavailable, such as, for vacation. Right clicking on a date on calendar 1102 generates box 1110. The user then selects whether he/she desires to “Add External Appointment” or “Mark As Vacation”. When “Add External Appointment” is selected, GUI 1150, shown in FIG. 11A, is generated, which asks for all of the details related to the external appointment. A drop-down box 1152 allows the user to select the appointment type, in this case, “External.” A “Select Task” option 1154 allows the user to select the task that is to be performed. The user can add the start and end times in blocks 1156 and 1158, respectively. A “Duration” box 1160 calculates the duration of time to perform the task based on the start and end times input into blocks 1156 and 1158. If the user desires to delete the task, such as, for example, if the customer cancels the appointment, the user can click on an “x” box 1162. To add the appointment to the user's calendar 1152, the user can click on an “Add” button 1164. After the user has input all desired external appointments, the user can click on a “Save” button 1166 to save the entry(ies) to system 100. Alternatively, if the user desires to cancel the entries, the user can click on “Cancel” button 1168, which will take the user back to GUI 1100.

After the appointment has been added, that appointment is shown on the calendar by using a different icon than that used to shown appointment that has been scheduled using system 100. “Mark As Vacation” marks the whole day as not available. This day can also be shown on the calendar with a different color.

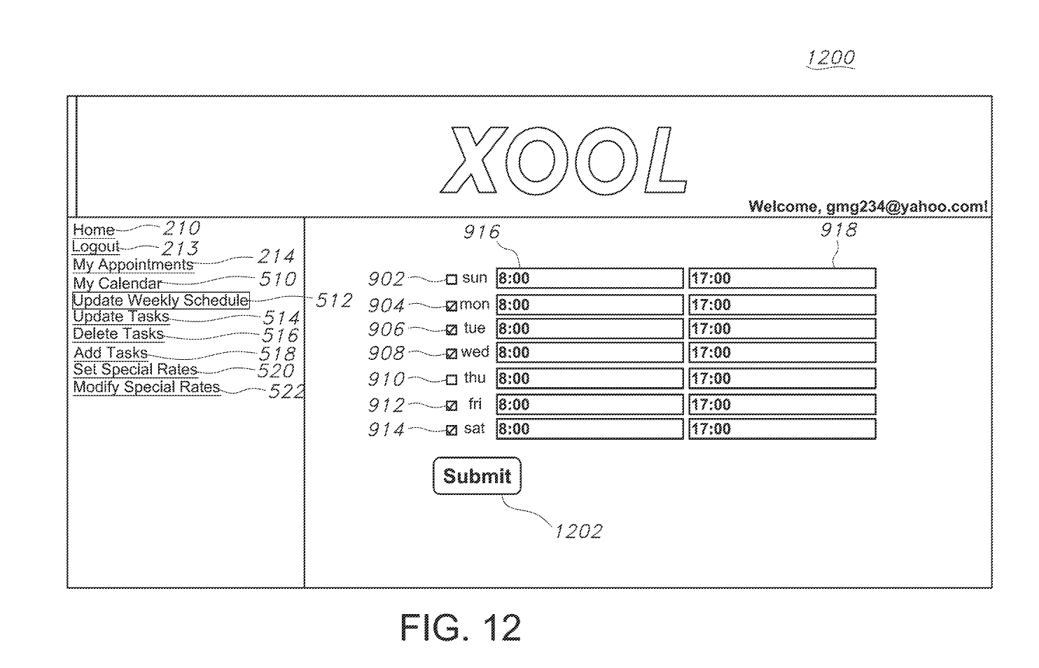

If the user clicks on “Update Weekly Schedule” icon 512, GUI 1200, shown FIG. 12, is generated. GUI 1200 is similar to GUI 900 in that it displays day of the week blocks 902-914, start times in box 916 and ending times in box 918 for each respective day. The user can click on any of blocks 902-914 to change the status of the particular day, with a checked block 902-914 meaning that the user is available to work on the associated day and an unchecked block 902-914 meaning that the user is unavailable to work the associated day. Additionally, the user can click on any of blocks 916 or 918 to modify the time in the respective block. After the user has made his/her updates, the user can click on “Submit” button 1202 which enters the new values into system database 110.

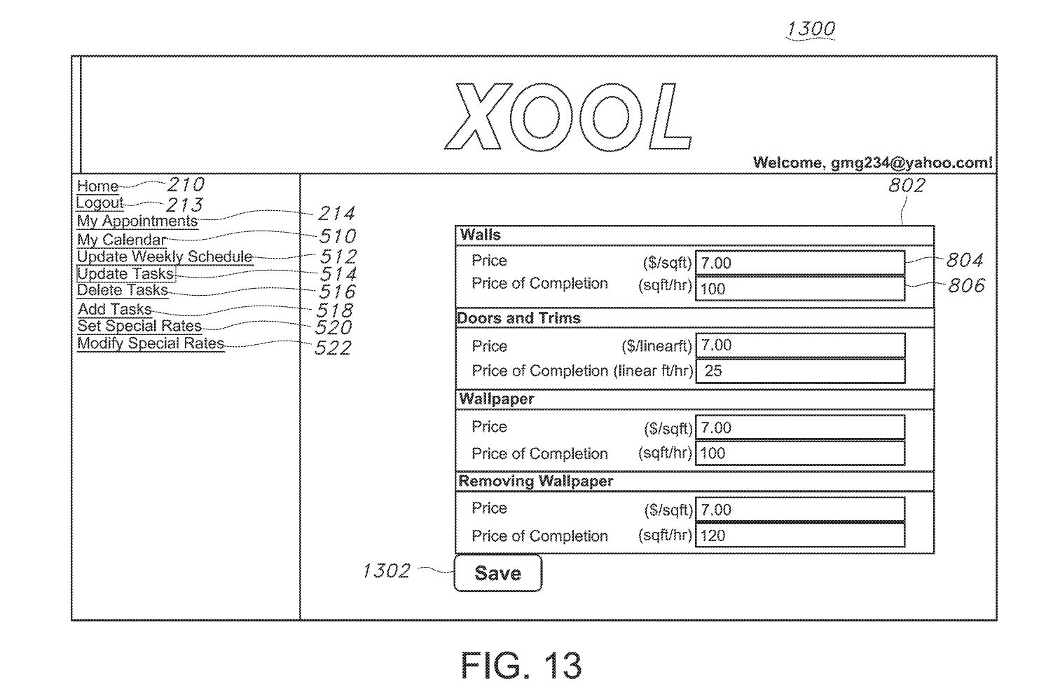

If the user clicks on “Update Tasks” icon 514, GUI 1300, shown FIG. 13, is generated. The user can select any of block 804 and 806 to adjust the price per unit measurement in block 804 and/or the rate of completion in block 806. The user inputs his/her updated rate information in blocks 804 and 806 and when he/she is finished, clicks on the “Save” button 1302, which enters the new values into system database 110.

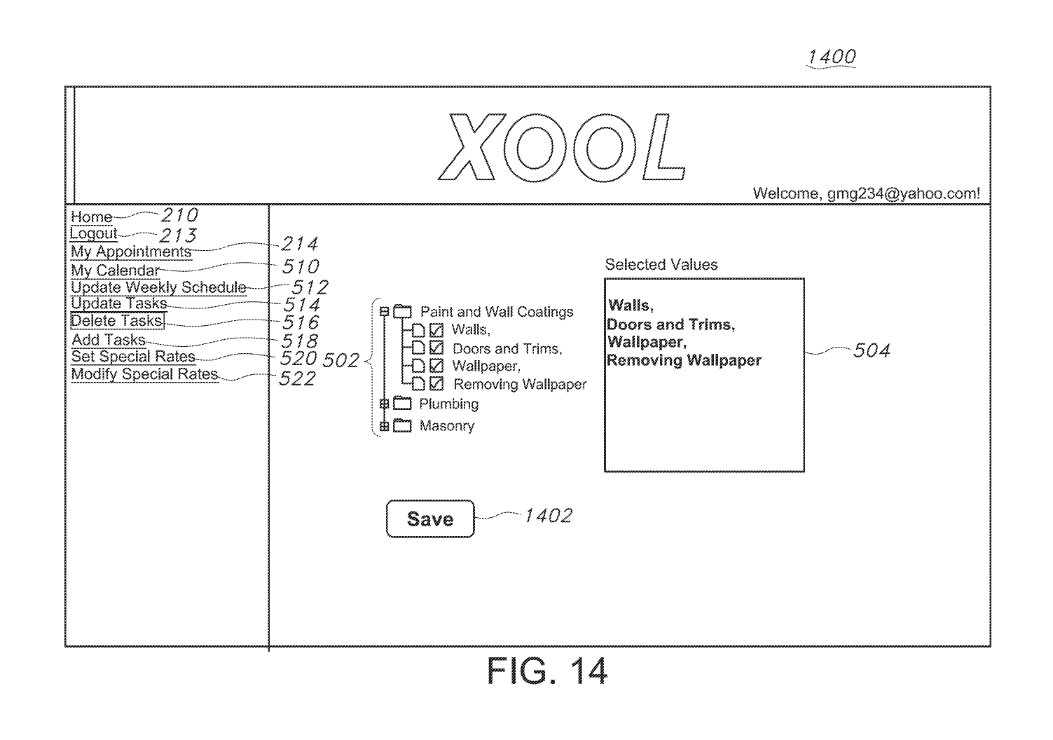

If the user clicks on “Delete Tasks” icon 516, GUI 1400, shown in FIG. 14, is generated. GUI 1400 is similar to GUI 500 and that the services that the user is able to provide are listed in box 504. The user can select tasks 502 that he/she no longer desires to provide and unchecks the box next to the specific tasks. Unchecking a box will remove the description of that task from box 504. After the user has deleted all desired tasks, the user clicks on button 1402 to save the changes to database 110.

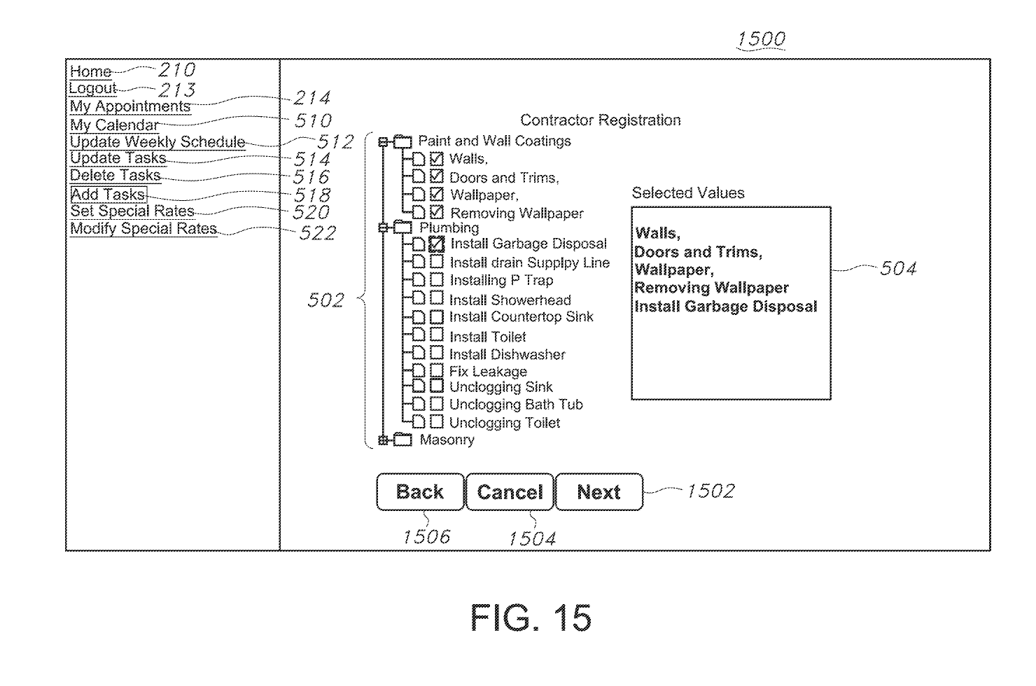

If the user clicks on “Add Tasks” icon 518, GUI 1500, shown in FIG. 15, is generated. GUI 1500 allows the user to add tasks to the list generated in GUI 500. The user clicks on tasks 502 to add that task to the list of tasks in box 504. After the user has selected all desire tasks, the user can click on “Next” button 1502 to save the changes and advance to GUI 600, shown in FIG. 6, which requires the user to input his/her license information required for the newly selected tasks.

If, however, the user desires to cancel the entries made in GUI 1500, the user clicks on “Cancel” button 1504 and all of the tasks 502 that have been checked to GUI 1500 are unchecked. If the user desires to return to the previous screen without saving any changes, the user clicks on “Back” button 1506, which returns the user to the previous GUI screen.

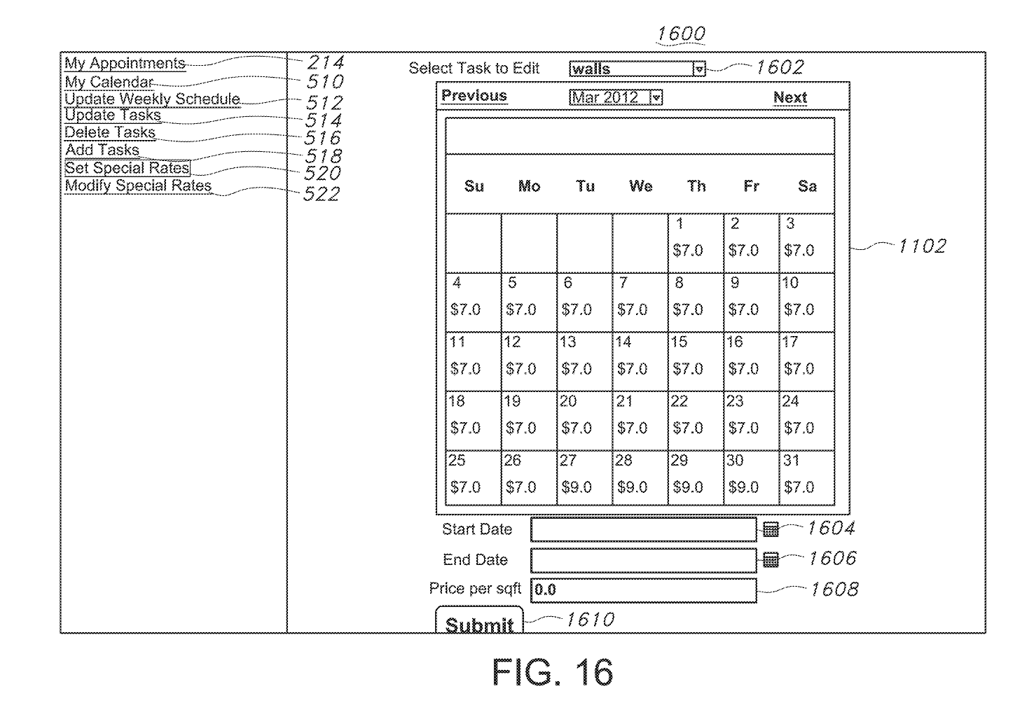

If the user clicks on “Set Special Rates” icon 520, GUI 1600, shown FIG. 16, is displayed. GUI 1600 displays calendar 1102 from GUI 1100, along with a selection bar 1602 that allows the user to scroll through the tasks from box 504. Each day of the week in calendar 1102 displays dollar values for the rate to perform the task selected in selection bar 1602. If, however, the user decides to set special rates for particular days, such as, for example, weekends and/or holidays, the user can enter a start date in box 1604 and in date in box 1606 and at a value in box 1608 to set the new rate. After the user has set the start and end dates in the new rate, the user clicks on button 1610 to submit the changes, which appear on calendar 1102. For example, while calendar 1102 in FIG. 16 includes a rate of $7.00 to perform the task of painting walls, for March 27-30, the user has changed the rate to $9.00.

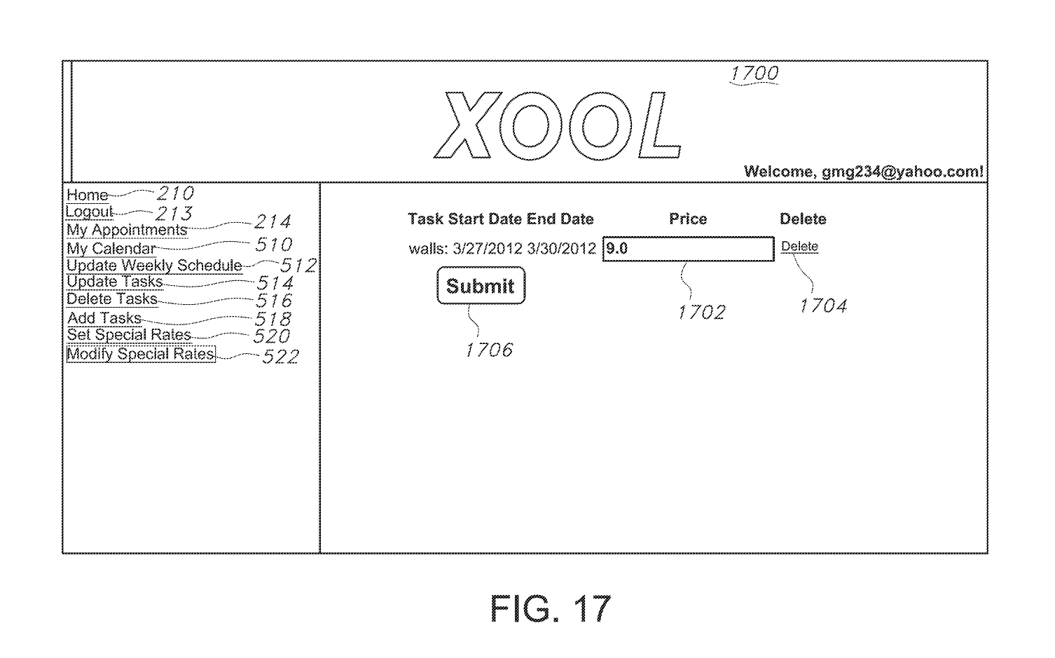

If, after the user has set special rates in GUI 1600, the user desires to modify the special rates, the user can click on “Modify Special Rates” icon 522 to generate GUI 1700 shown in FIG. 17. GUI 1700 displays all of the special rates and allows the user to modify the rate in box 1702. If the user desires to eliminate a special rate, the user can click on “Delete” icon 1704 to delete this particular special rate from database 110. After the user has made all of his/our desired edits to the special rates, the user clicks on the “Submit” button 1706 to save the changes in database 110.

If, regarding GUI 1000-1700, the user desires to exit from system 100 without making any additional changes, the user clicks on the “Logout” icon 513 to exit from system 100.

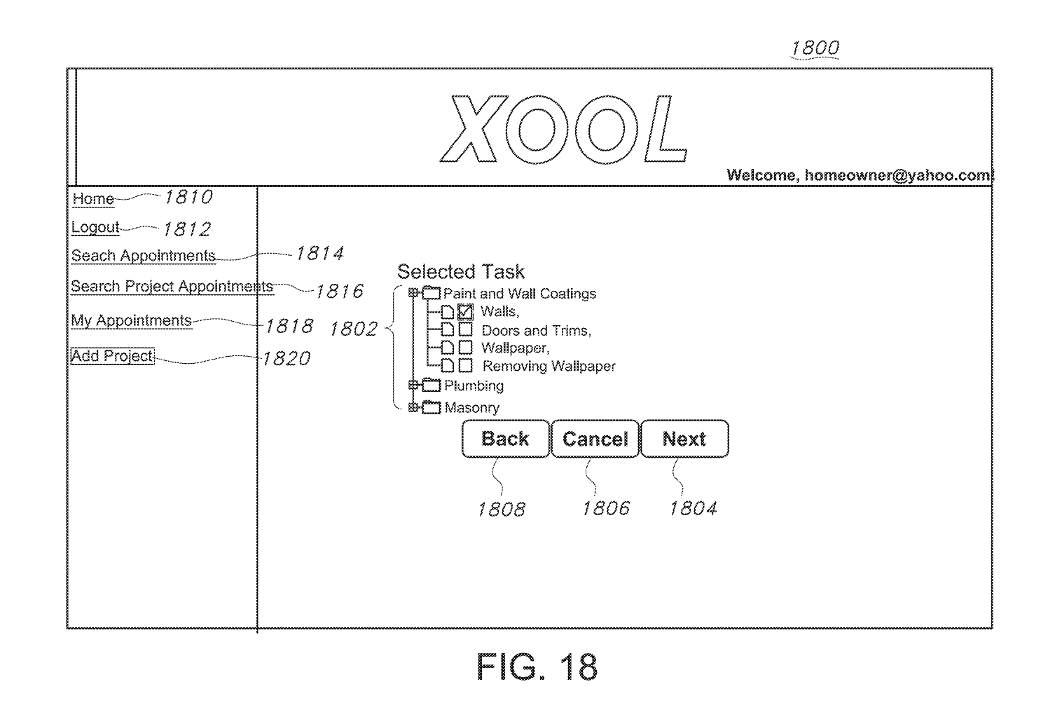

Referring back to GUI 300 and FIG. 3, if the user is a consumer, the user clicks on “Consumer” box 304, which generates GUI 1800, shown in FIG. 18. GUI 1800-2300 (FIGS. 18-23) are GUI screens accessible to the consumer only; the contractor does not have access to the screens.

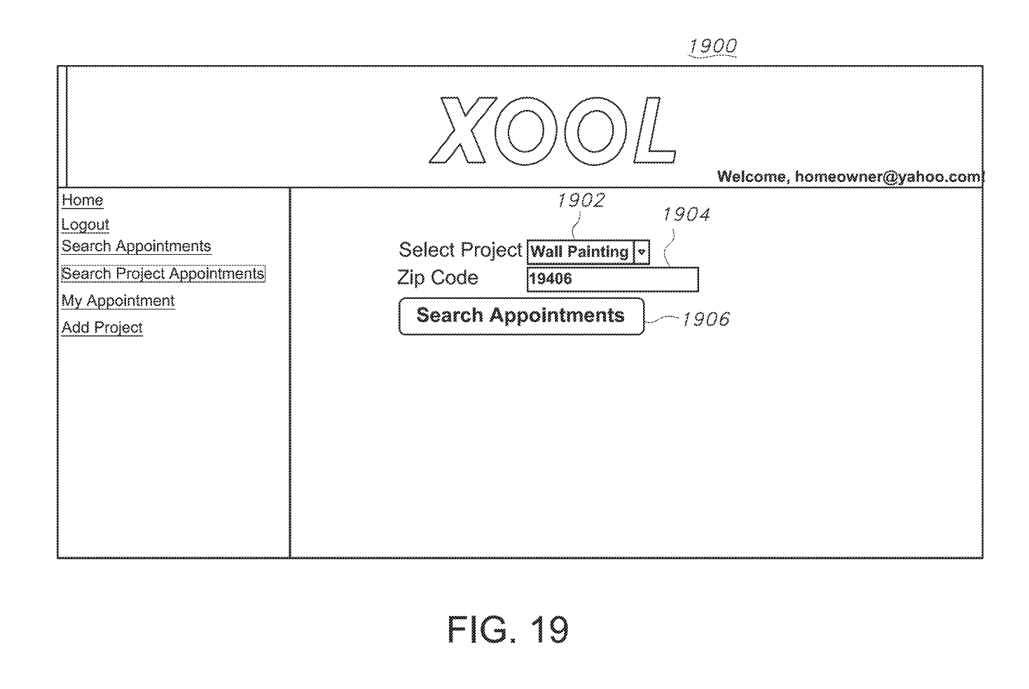

GUI 1800 displays a list of tasks 1802 from which the user can select to obtain a quote and schedule an appointment. Each task has a checkbox next to it that the user can check to identify the specific tasks. For searching appointments, the consumer can choose a single task or, if desired, the consumer can choose multiple tasks by selecting multiple checkboxes. After the user has selected the desired task(s), the user can click on “Next” button 1804 to save the changes and advances to GUI 1900, shown in FIG. 19. If, however, the user desires to cancel the entries made in GUI 1600, the user clicks on “Cancel” button 1806 and all of the tasks 1802 that have been checked in GUI 1800 are unchecked. If the user desires to return to the previous screen without saving any changes, the user clicks on “Back” button 1808, which returns the user to the previous GUI screen.

The left hand side of GUI 1800, along with GUI 1900, 2000, 2200, and 2300 includes a “Home” icon 1810, a “Logout” icon 1812, a “Search Appointments” icon 1814, a “Search Project Appointments” icon 1816, a “My Appointments” icon 1818, and an “Add Project” icon 1820. If the user clicks “Home” icon 1810, system 100 generates GUI 300, shown in FIG. 3. If the user clicks “Logout” icon 1812, GUI 200, shown FIG. 2, is generated.

Referring to FIG. 19, the user clicks on drop-down menu 1902 to select projects to be performed by the contractor. In block 1904, the user adds his/her zip code. The zip code is used to allow system 100 to select contractors located within a predetermined radius of the zip code and also applies any special rates that the contractor has set for working that particular ZIP code. For example, as stated above, the contractor may have different rates for different areas. By way of example only, a contractor may have a relatively higher rate for work to be performed in Manhattan and a relatively lower late for work to be performed in Brooklyn.

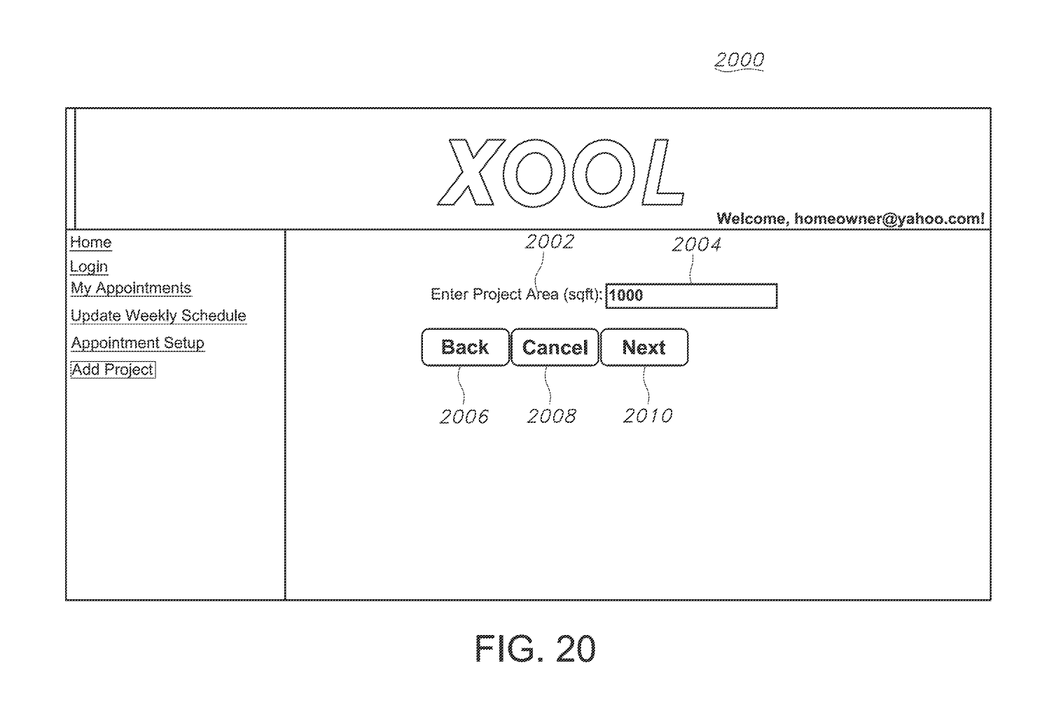

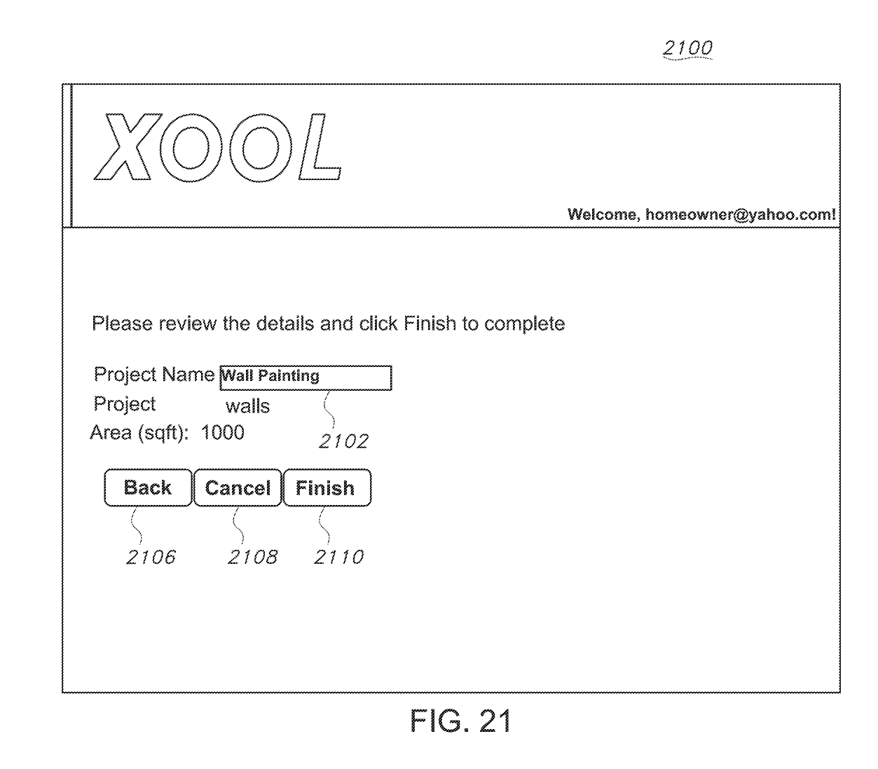

After the user has selected the project and input his/her zip code, the user clicks on button 1906, which generates GUI 2000, shown FIG. 20. Based on the project selected in drop-down menu 1902, a measured area is provided at 2002. In this particular example, because the project selected the job done menu 1902 was “Wall Painting”, the measured area is in square feet. The user inputs the measured area in block 2004 and clicks on either “Back” button 2006 to go back to GUI 1900, “Cancel” button 2008 to go to GUI 1800, or “Next” button 2010 to go to GUI 2100 in FIG. 21.

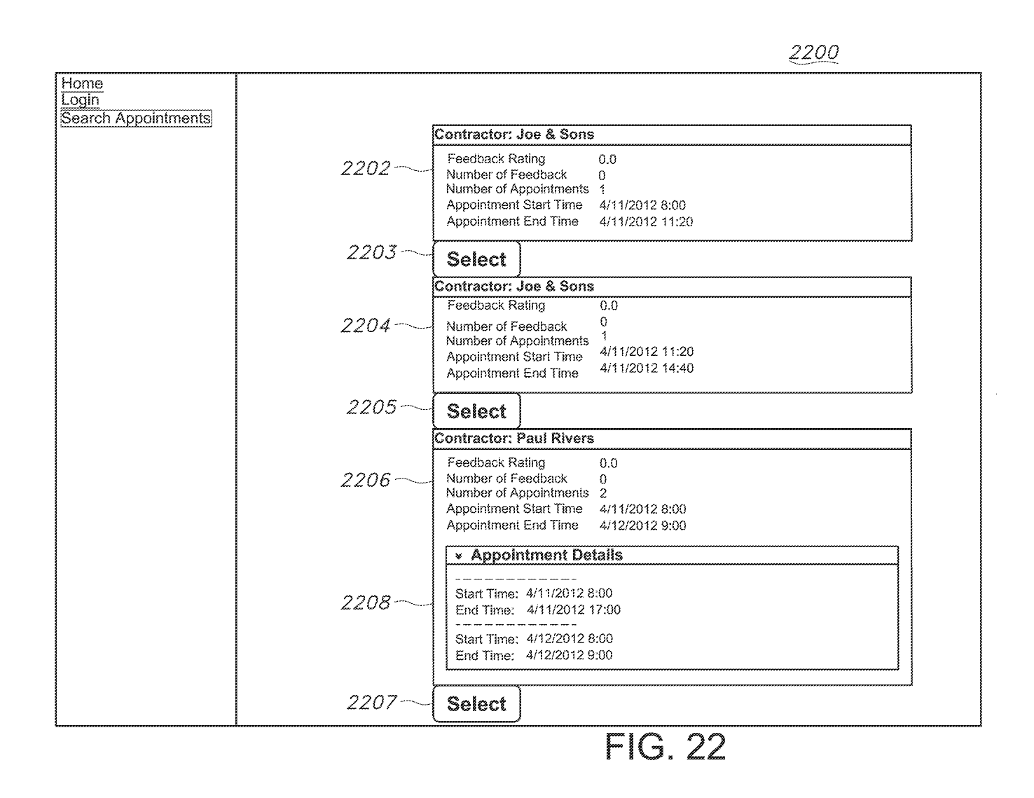

GUI 2100 confirms the type of project and measured area and allows the user to name the project in block 2102. The user then clicks on either “Back” button 2106 to go back to GUI 2000, “Cancel” button 2108 to go to GUI 1800, or “Finish” button 2110 to go to GUI 2200, shown in FIG. 22.

Referring back to FIG. 1, an appointment search algorithm 140 is used to search for possible appointments that fit with project details entered by the homeowner. One of the criteria used by appointment search algorithm 140 is the availability of the contractor, for appointment availabilities that span across multiple days on a continued basis, (i.e. without taking a considerable break in between the start and end dates of the project). For example, for a project that requires five (5) days from contractor, the contractor should be able to make five (5) appointments continuously without having a pre-defined break in between. This period of pre-defined maximum break will be defined by system 100 and can be customized by the homeowner. For a five (5) day appointment, for example, the maximum default break may be two (2) days. For longer appointments, the maximum break can be longer.

Additionally, appointment search algorithm 140 takes into account certain tasks that, by their nature, take multiple visits to complete. For example, concrete work, drywall mudding, and painting projects may require time to dry prior to completing the project, necessitating multiple days to complete. Appointment search algorithm 140 therefore intentionally breaks up such exemplary tasks into multiple days and searches for multiple day availabilities for potential contractors.

Based on the results of appointment search algorithm 140, GUI 2200 provides a list of potential contractors, and provides, in box 2202-2206, feedback rating provided by prior customers, the number of feedbacks and the number of appointments that each potential contractor has obtained through system 100. Additionally, the contractors' available appointment start/end times are provided to allow the user to determine the most convenient time during which to schedule the contractor. An “Appointment Details” box 2208 shows the total availability of the contractor on the selected day as well as the start time and end time for the selected project.

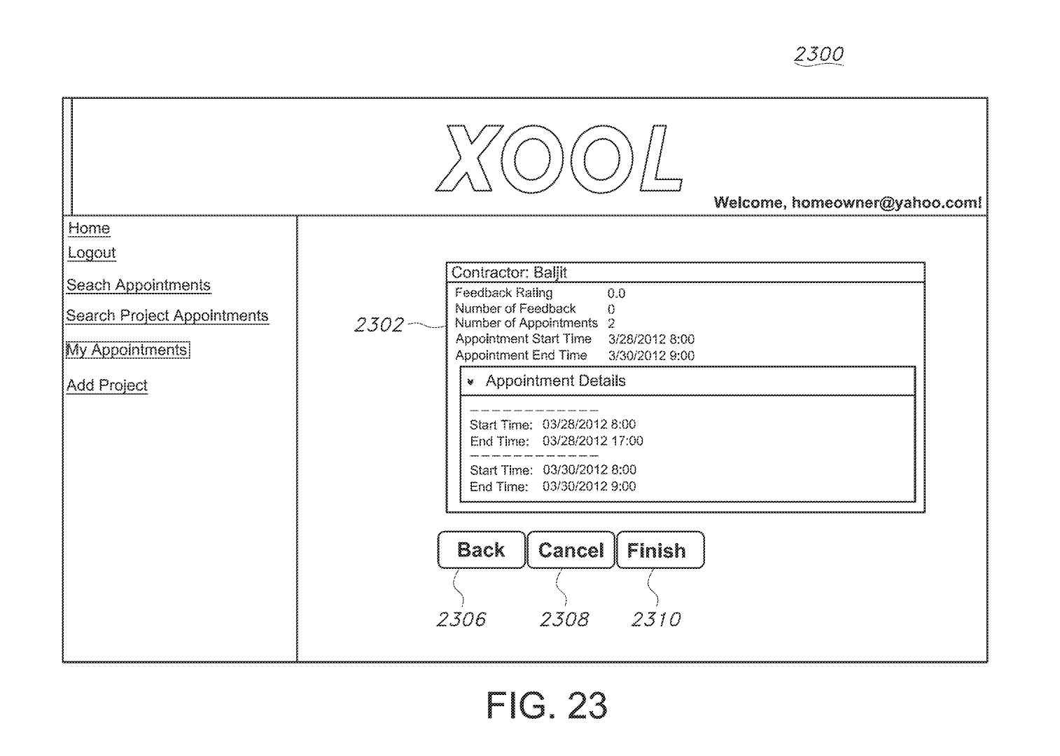

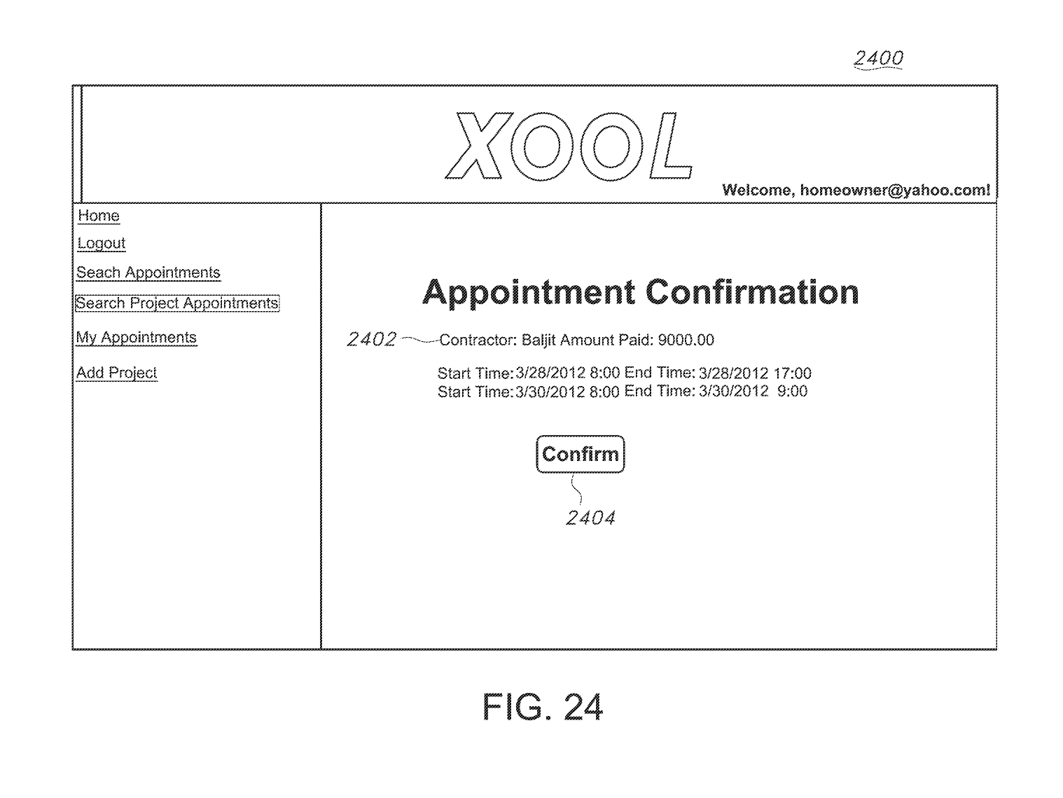

The user can click on “Select” button 2203, 2205, or 2207 to select a desired contractor. By clicking on desired “Select” button 2203, 2205, or 2207, system 100 generates GUI 2300, shown FIG. 23, which shows the selected contractor information in block 2302. The user then clicks on either “Back” button 2306 to go back to GUI 2200, “Cancel” button 2308 to go to GUI 1800, or “Finish” button 2310 to go to GUI 2400, shown in FIG. 24.

GUI 2400 provides an “Appointment” confirmation” listing in section 2402, showing the name of the contractor, the amount to be paid, and the duration of the work to be performed. If the user agrees with this information and desires to confirm the appointment, the user clicks on a “Confirm” button 2404, which transmits the appointment information to the contractor.

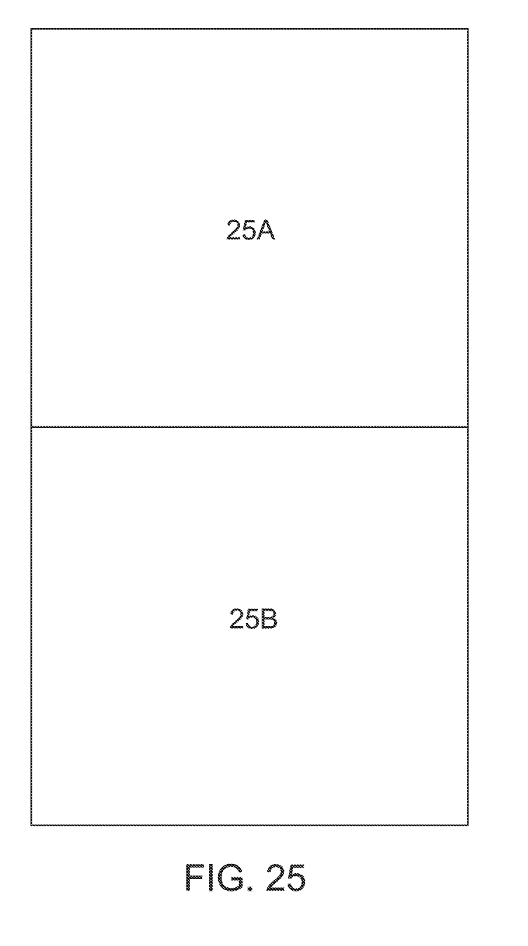

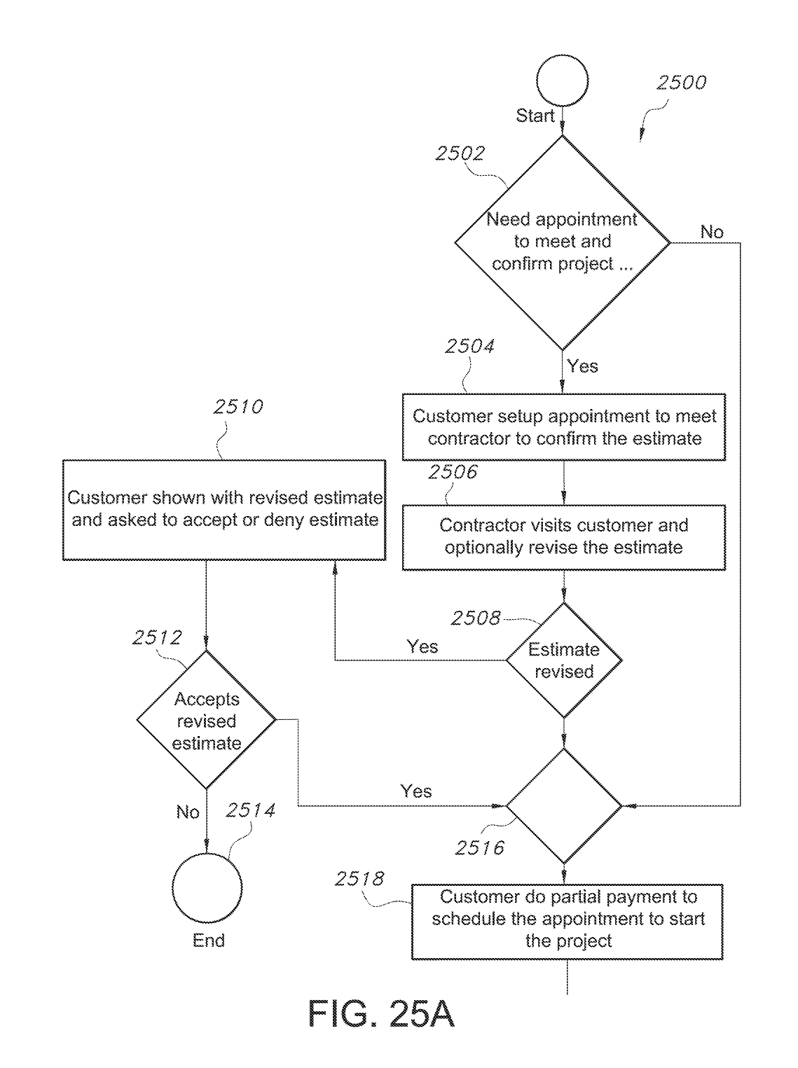

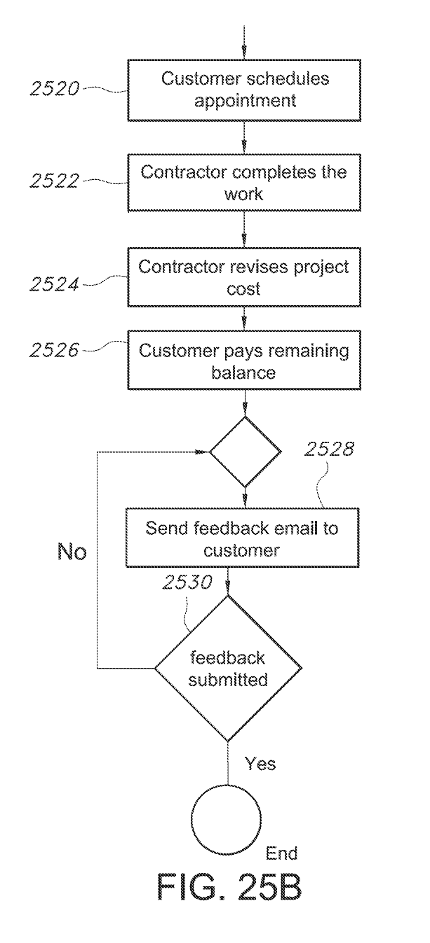

After the contractor receives the appointment information, the contractor and the consumer must jointly agree that the contractor will perform the project for an agreed-upon price. An exemplary method that may be used is illustrated in flowchart 2500, shown FIG. 25. In step 2502, the consumer determines whether an appointment is required to meet with the contractor from the project and the cost. If an appointment is required, in step 2504, the customer set up an appointment to meet with the contractor and to confirm the estimate and, in step 2506, the contractor visits the customer to review and discuss the prospective job. In step 2508, the contractor may optionally revise the estimate. If the contractor does revise an estimate that has been generated by system 100 for the project, his/her per unit rates and/or flat prices are also updated to reflect the revised estimate. Additionally, in step 2510, the contractor shows the customer a revised estimate and, in step 2512, is asked to accept or refuse the estimate.

If the customer refuses the revised estimate, in step 2514, the customer and the contractor have not come to an agreement and do not enter into a contract for the contractor to perform the work. If, however, the customer accepts the revised estimate, the customer accepts the contractor's cost estimate in step 2516. Additionally, the contractor's per unit rates will be revised by system 100 according to the revised estimate and these revised per unit rates will be reflected in database 110 for this particular contractor.

If, back in step 2502, the customer does not desire an appointment to meet and confirm the project estimate, steps 2502-2514 can be eliminated, with the customer accepting the estimate in step 2516. In step 2518, the customer can provide a partial payment to the contractor to schedule an appointment on the contractor's calendar to perform the required task. In step 2520, the customer schedule the appointment and, in step 2522, the contractor performs the work. In step 2524, the contractor may revise the project costs according to actual costs and, in step 2526, the customer pays the remaining balance to the contractor.

After a project is completed by the contractor, in step 2528, an e-mail is sent to the consumer to provide a feedback rating for the contractor. The consumer provides feedback in step 2530 by clicking on links in the email. The consumer does not need to login to the system to provide this feedback. If, after a predetermined amount of time, the consumer has not provided feedback, and reminder e-mail is sent to the consumer, who was asked to provide feedback in step 2528.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method for selecting a contractor comprising the steps of:
providing a contractor database, the database allowing the contractor to input contractor information;
displaying a list of tasks that the contractor offers to perform and a billable rate at which the contractor offers to perform each task on the list;
allowing the user to input a list of desired tasks to be performed and available dates for the contractor to perform each desired task;
generating a list of contractors available to perform the desired tasks within the available dates; and
allowing the user to select a contractor from the list of contractors.

2. The method according to claim 1, further comprising allowing the user to select a starting date, and an ending date for the contractor to perform the desired tasks from the available dates.

3. The method according to claim 2, further comprising generating non-working dates between the starting date and ending date for predetermined tasks.

4. The method according claim 3, further comprising allowing the user to determine a number of non-working dates.

5. The method according to claim 2, for predetermined tasks, requiring the ending date to be a date after the starting date.

6. The method according to claim 1, wherein the billable rate varies according to location.

7. The method according claim 1, wherein the billable rate varies according to day.

8. The method according to claim 1, wherein the state information comprises contractor licensing information.

9. The method according claim 8, wherein, if the contractor licensing information indicates that the contractor's license has expired, the method further comprising determining that comparison of the contractor information and state information does not meet the predetermined criteria.

10. The method according to claim 1, further comprising:
accessing a state-generated contractor licensing database, the licensing database containing state information about the contractor;
comparing the contractor inputted contractor information with the state information; and
displaying the contractor information on the user interface only if the comparison of the contractor information and the state information meets predetermined criteria.

11. A method for selecting a contractor comprising the steps of:
providing a contractor database, the database allowing the contractor to input contractor information;
displaying a list of tasks that the contractor offers to perform and a billable rate at which the contractor offers to perform each task on the list;
displaying available dates when the contractor is available to perform each task on the list; and
allowing the user to select the contractor.

12. The method according claim 11, further comprising allowing the contractor to manually eliminate available dates.

13. The method according claim 11, wherein the user is allowed to select the contractor based on the displayed available dates.

14. The method according claim 13, further comprising, upon the user selecting the contractor, automatically eliminating at least some of the available dates from the displayed available dates.

15. The method according claim 11, wherein at least one task on the list requires a plurality of dates to be performed and wherein the displayed available dates comprise consecutive dates equal or greater than the plurality of dates.

16. The method according to claim 11, wherein the available dates are not consecutive.

17. The method according to claim 10, wherein displaying the contractor comprises displaying a list of contractors available perform each task on the list.

18. The method according to claim 17, further comprising displaying pricing rates for each contractor on the list of contractors.

19. A non-transitory machine-readable storage medium, having encoded thereon program code, wherein, when the program code is executed by a machine, the machine implements a method for selecting a contractor, comprising the steps of:
providing a contractor database, the database allowing the contractor to input contractor information;
displaying a list of tasks that the contractor offers to perform and a billable rate at which the contractor offers to perform each task on the list;
allowing the user to input a list of desired tasks to be performed and available dates for the contractor to perform each desired task;
generating a list of contractors available to perform the desired tasks within the available dates; and
allowing the user to select a contractor from the list of contractors.
